(19) United States
(12) Patent Application Publication
(10) Pub. No.: US 2023/0268757 A1
(43) Pub. Date: Aug. 24, 2023

(54) CIRCUIT DEVICE AND ELECTRONIC APPARATUS

(71) Applicant: SEIKO EPSON CORPORATION, Tokyo (JP)

(72) Inventor: Masaya Ninomiya, Matsumoto-shi (JP)

(21) Appl. No.: 18/170,908

(22) Filed: Feb. 17, 2023

(30) Foreign Application Priority Data
Feb. 22, 2022 (JP) 2022-025180
Jul. 19, 2022 (JP) 2022-114595

(51) Int. Cl. H02J 7/00

(52) U.S. Cl. CPC H02J 7/00714

(57) ABSTRACT

A circuit device includes a current source circuit, a first charging circuit, a second charging circuit, and a control circuit. The first charging circuit supplies a first charging current as a constant current based on an output current of the current source circuit. The second charging circuit supplies a second charging current which is a constant current and is higher than the first charging current based on the output current of the current source circuit. The control circuit makes the first charging circuit supply the first charging current when a current value of the charging current is determined as a current value in the first current mode. The control circuit makes the second charging circuit supply the second charging current when the current value of the charging current is determined as a current value in the second current mode higher than the current value in the first current mode.

The present application is based on, and claims priority from JP Application Serial Number 2022-025180, filed Feb. 22, 2022, the disclosure of which is hereby incorporated by reference herein in its entirety.

### BACKGROUND

### 1. Technical Field

The present disclosure relates to a circuit device, an electronic apparatus, and so on.

### 2. Related Art

In JP-A-10-028338 (Document 1), there is disclosed a charging device for charging a secondary battery from two charging power supplies different in voltage from each other. The voltage of one of the power supplies is slightly lower than a reference voltage which is used when charging the secondary cell, and the voltage of the other of the power supplies is higher than the reference voltage. The charging device detects a battery voltage, and then charges the battery with the two power supplies when the battery voltage is lower than the voltages of the two power supplies. When the secondary battery is charged to a certain degree, and the battery voltage exceeds the voltage of the power supply lower in voltage, the charging device charges the secondary battery only with the power supply higher in voltage. In Document 1, a charging current lowers as the secondary battery is charged, and by detecting the charging current, the charging is terminated. Further, by switching the number of the charging power supplies from two to one based on the battery voltage when the secondary battery is charged to a certain degree, the detection accuracy of the charging current is increased.

In the circuit for charging the battery with constant current, there is a problem that it is difficult to deal with the charging current in a variety of values from a high value to a low value. For example, when attempting to increase a settable maximum value of the charging current, a resolution of current setting lowers, or a scale of a current source circuit increases. Document 1 described above discloses a configuration in which the charging current lowers as the secondary battery is charged, and Document 1 does not disclose or suggest a configuration in which the circuit for charging the battery with constant current deals with the charging current in a variety of values from a high value to a low value.

### SUMMARY

An aspect of the present disclosure relates to a circuit device including a current source circuit, a first charging circuit configured to supply a charging node with a first charging current which is a constant current as a charging current based on an output current of the current source circuit, a second charging circuit configured to supply the charging node with a second charging current which is a constant current and is higher than the first charging current as the charging current based on the output current of the current source circuit, and a control circuit, wherein the control circuit performs control in a first current mode of making the first charging circuit supply the charging node with the first charging current when a current value of the charging current is determined as a current value in the first current mode, and control in a second current mode of making the second charging circuit supply the charging mode with the second charging current when the current value of the charging current is determined as a current value in the second current mode higher than the current value in the first current mode.

Further, another aspect of the present disclosure relates to an electronic apparatus including the circuit device described above, and a battery to be coupled to the charging node.

### BRIEF DESCRIPTION OF THE DRAWINGS

FIG. 1 is a diagram showing a constant-current charging circuit when a method according to the present embodiment is not used.

FIG. 2 is a diagram showing examples of parameters of the constant-current charging circuit when the method according to the present embodiment is not used.

FIG. 3 is a configuration example of a circuit device and an electronic apparatus according to the present embodiment.

FIG. 4 is a diagram showing a detailed configuration example of the circuit device according to a first embodiment.

FIG. 5 is a diagram showing a detailed configuration example of a first charging circuit and a first current source circuit.

FIG. 6 is a diagram showing a detailed configuration example of a second charging circuit and a second current source circuit.

FIG. 7 is an explanatory diagram of an operation of a control signal output section in the first embodiment.

FIG. 8 is a diagram for explaining a resistance ratio and an operation of the current source circuit corresponding to each of current modes in the first embodiment.

FIG. 9 is a diagram showing parameter examples of the first charging circuit, the first current source circuit, the second charging circuit, and the second current source circuit.

FIG. 10 is a diagram showing a detailed configuration example of a current source circuit in a second embodiment.

FIG. 11 is an explanatory diagram of an operation of a control signal output section in the second embodiment.

FIG. 12 is a diagram for explaining a resistance ratio and an operation in each of current modes of the current source circuit in the second embodiment.

### DESCRIPTION OF EXEMPLARY EMBODIMENTS

Some preferred embodiments of the present disclosure will hereinafter be described in detail. It should be noted that the present embodiments described hereinafter do not unreasonably limit the content as set forth in the appended claims, and all of the constituents described in the present embodiments are not necessarily essential constituent requirements.

### 1. Configuration Example of Circuit Device and Electronic Apparatus

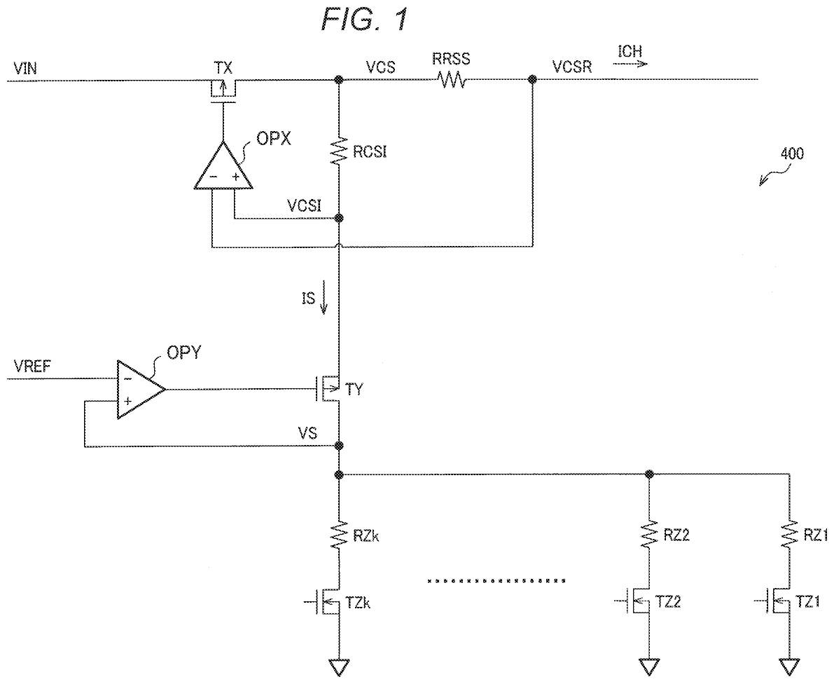

First, a constant-current charging circuit and a problem thereof when a method of the present embodiment is not used will be described. FIG. 1 shows a configuration example of the constant-current charging circuit 400. The constant-current charging circuit 400 includes operational amplifiers OPX, OPY, P-type transistors TX, TY, resistors RRSS, RCS1, and RZ1 through RZk, and N-type transistors TZ1 through TZk. The character k denotes an integer no smaller than 2.

The operational amplifier OPY controls the gate voltage of the P-type transistor TY so that the drain voltage of the P-type transistor TY fulfills VS=VREF. The character string VREF denotes a reference voltage. When the N-type transistor TZ1 is in the ON state, a current of VREF/RZ1 flows through the resistor RZ1. Similarly, when the N-type transistors TZ2 through TZk are in the ON state, currents of VREF/RZ2 through VREF/RZk flow through the resistors RZ2 through RZk, respectively. RZ2=RZ1/2, RZ3=RZ1/4, . . . , RZk=RZ1/2^{k-1} are assumed. When defining the current flowing through the resistor RZ1 as IZ1, the currents flowing through the resistors RZ2, RZ3, . . . , RZk are binary-weighted as IZ1×2, IZ1×4, . . . , IZ1×2^{k-1}, respectively. A sum of the currents flowing through the resistors coupled to the N-type transistor set to the ON state out of the N-type transistors TZ1 through TZk becomes a current IS flowing through the P-type transistor TY.

The source of the P-type transistor TX is supplied with a power supply voltage VIN. The voltages of one end of the resistor RCSI and one end of the resistor RRSS are defined as VCS, the voltage of the other end of the resistor RCSI is defined as VCSI, and the voltage of the other end of the resistor RRSS is defined as VCSR. The operational amplifier OPX controls the gate voltage of the P-type transistor TX so that VCSI=VCSR is true. Thus, VCS−VCSI=VCS−VCSR becomes true. Since the current IS flows through the resistor RCSI, VCS−VCSI=RCSI×IS is obtained. When the charging current is defined as ICH, since the charging current ICH flows through the resistor RRSS, VCS−VCSR=RRSS×ICH is true. According to the above, RCSI×IS=RRSS×ICH is true, and the charging current becomes ICH=(RCSI/RRSS)×IS. By each of the N-type transistors TZ1 through TZk being controlled to the ON state or the OFF state, the current value of the current IS is set, and thus, the current value of the charging current ICH is set.

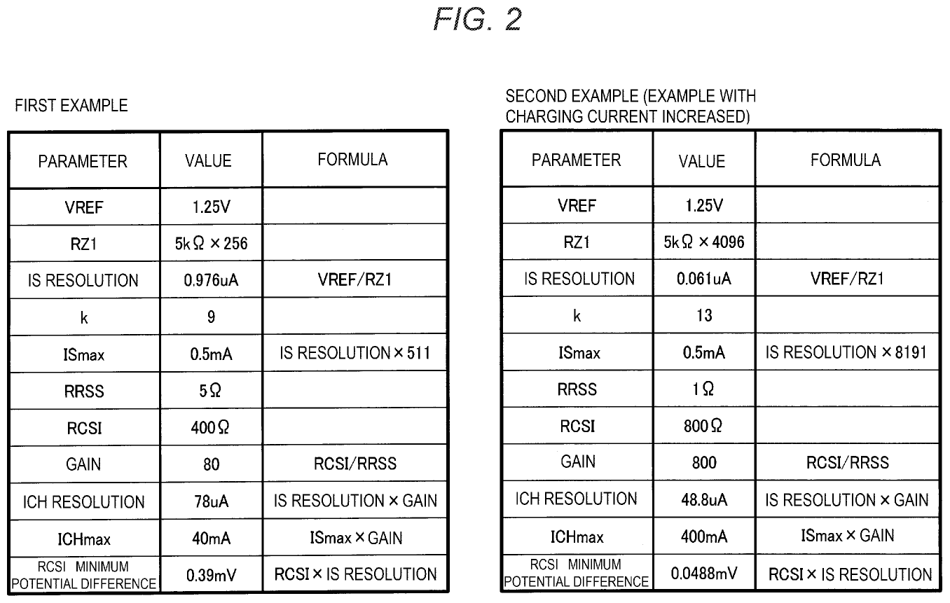

FIG. 2 shows a parameter example of the constant-current charging circuit 400 shown in FIG. 1. In both of a first example in the left diagram and a second example in the right example, the reference voltage is set to VREF=1.25 V.

The first example is an example in which the maximum value ICHmax of the charging current is set to 40 mA. In this example, RZ1=5 kΩ×256 is true, and the resolution of the current IS becomes VREF/RZ1=0.976 μA. The resistor RZ1 is configured by coupling 256 unit resistors of, for example, 5 kΩ in series to each other. When k=9 is assumed, the maximum value ISmax of the current IS is (IS resolution)×511=0.5 mA. When RRSS=5Ω and RCSI=400Ω are assumed, the gain is RCSI/RRSS=80. The resolution of the charging current ICH becomes (IS resolution)×gain=78 μA, and the maximum value ICHmax of the charging current becomes ISmax×gain=40 mA. A minimum potential difference between both ends of the resistor RCSI becomes RCSI×(IS resolution)=0.39 mV.

The second example is an example in which the maximum value ICHmax of the charging current is set to 400 mA ten times as high as above while substantially keeping the resolution of the charging current. For example, in order to correct a variation in the charging current due to a variation in process, the resolution of the charging current is necessary. Therefore, it is desirable to keep or increase the resolution even when increasing the charging current.

In the second example, RZ1=5 kΩ×4096 is true, and the resolution of the current IS becomes VREF/RZ1=0.061 μA. The resistor RZ1 is configured by coupling 4096 unit resistors of, for example, 5 kΩ in series to each other. When k=13 is assumed, the maximum value ISmax of the current IS is (IS resolution)×8191=0.5 mA. When RRSS=1Ω and RCSI=800Ω are assumed, the gain is RCSI/RRSS=800. The resolution of the charging current ICH becomes (IS resolution)×gain=48.8 μA, and the maximum value ICHmax of the charging current becomes ISmax×gain=400 mA. A minimum potential difference between the both ends of the resistor RCSI becomes RCSI×(IS resolution)=0.0488 mV.

When comparing the first example and the second example described above with each other, the resistor RZ1 is 5 kΩ×256 in the first example, and is 5 kΩ×4096 in the second example. In other words, compared to the first example, in the second example, the circuit scale of the resistor increases. Further, the minimum potential difference between the both ends of the resistor RCSI is 0.39 mV in the first example, and is 0.0488 mV in the second example. When the minimum potential difference between the both ends of the resistor RCSI is too small as in the second example, it becomes unachievable to chop the charging current ICH with the resolution higher in accuracy due to an influence of an offset of the operational amplifier OPX and so on. As described above, when increasing the maximum value ICmax of the charging current while keeping the resolution of the charging current ICH, the circuit scale of the resistors RZ1 through RZk increases, or the minimum potential difference between the both ends of the resistor RCSI decreases.

In the second example, by increasing the gain of the current from 80 times to 800 times, the maximum value of the charging current ICH is increased. As another method, it is possible to increase the maximum value of the charging current ICH by increasing the maximum value ISmax of the current IS while suppressing the gain of the current to some extent. However, since the current IS is a current which is not used for charging, and flows into the ground, the smaller the current IS is the more desirable in terms of power efficiency.

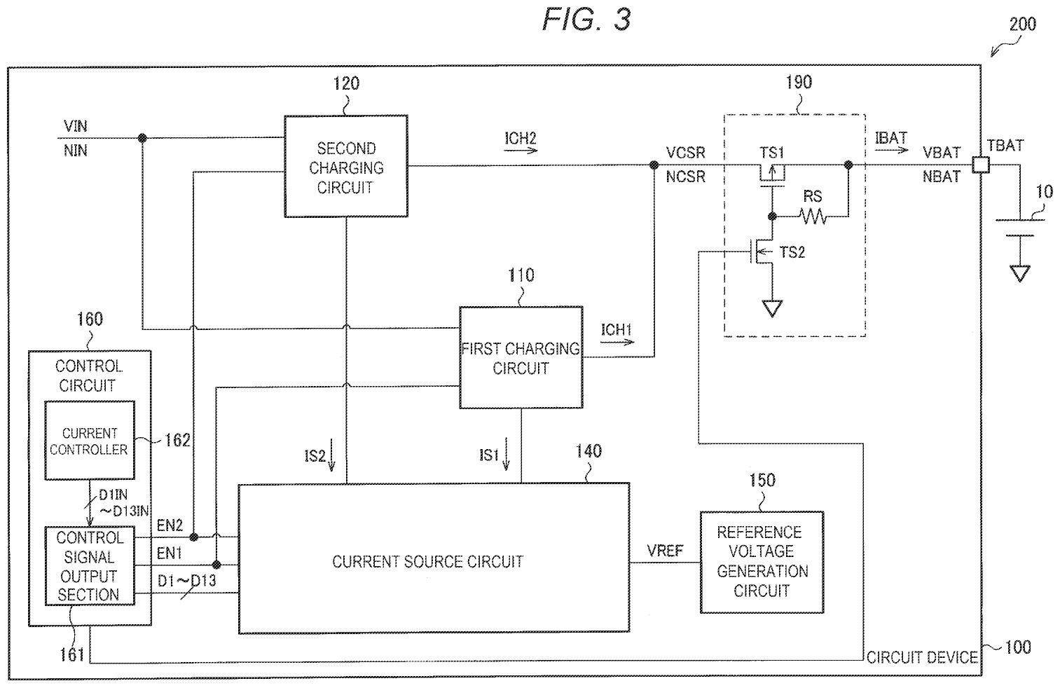

FIG. 3 shows a configuration example of a circuit device 100 according to the present embodiment, and an electronic apparatus 200 including the circuit device 100.

The electronic apparatus 200 includes the circuit device 100 and a battery 10. The battery 10 is a secondary battery such as a lithium-ion secondary battery, a nickel-hydrogen storage battery, or a nickel-cadmium storage battery. It is sufficient for the electronic apparatus 200 to be an apparatus which is capable of incorporating the battery 10, or to which the battery 10 can be attached. As an example, the electronic apparatus 200 is a smartphone, a tablet terminal, a wireless earphone, a wireless hearing aid, a smart watch, a digital camera, a mobile battery, or the like. When the electronic apparatus 200 is the smartphone or the like, it is possible for the electronic apparatus 200 to include a processing device, a storage device, a wireless communication device, a display device, an operation input device, or the like.

The circuit device 100 charges the battery 10 based on a power supply supplied from the outside. The circuit device 100 includes a first charging circuit 110, a second charging circuit 120, a current source circuit 140, a reference voltage generation circuit 150, a control circuit 160, a back-flow prevention circuit 190, and a terminal TBAT. The circuit device 100 is, for example, an integrated circuit device having a plurality of circuit elements integrated in a semiconductor substrate.

The back-flow prevention circuit 190 is disposed between an output node NCSR of the first charging circuit 110 and the second charging circuit 120, and a charging node NBAT coupled to the terminal TBAT. To the terminal TBAT, there is coupled a terminal of the battery 10. By the control circuit 160 turning ON the back-flow prevention circuit 190, a first charging current ICH1 from the first charging circuit 110 or a second charging current ICH2 from the second charging circuit 120 is supplied to the charging node NBAT as a charging current IBAT. By the charging current IBAT being supplied from the terminal TBAT to the battery 10, the battery 10 is charged.

The back-flow prevention circuit 190 includes a P-type transistor TS1, an N-type transistor TS2, and a resistor RS. The source of the P-type transistor TS1 is coupled to the charging node NBAT, and the drain is coupled to the output node NCSR. The source of the N-type transistor TS2 is coupled to a ground node, and the drain is coupled to the gate of the P-type transistor TS1. One end of the resistor RS is coupled to the charging node NBAT, and the other end is coupled to the gate of the P-type transistor TS1. When the control circuit 160 turns OFF the N-type transistor TS2, the P-type transistor TS1 turns OFF. Since the P-type transistor TS1 has a parasite diode taking a direction from the output node NCSR to the charging node NBAT as a forward direction, the back-flow prevention circuit 190 prevents the back flow from the battery 10 toward the first charging circuit 110 and the second charging circuit 120 when the P-type transistor TS1 is in the OFF state. When the charging to the battery 10 is performed, the control circuit 160 turns ON the N-type transistor TS2. Thus, the P-type transistor TS1 turns ON. Hereinafter, the charging operation of the back-flow prevention circuit 190 when the P-type transistor TS1 is in the ON state will mainly be described.

The reference voltage generation circuit 150 generates the reference voltage VREF. The reference voltage generation circuit 150 is, for example, a bandgap reference circuit, but is not limited thereto. It should be noted that it is possible for the reference voltage VREF to be supplied from the outside of the circuit device 100.

The control circuit 160 controls the charging to the battery 10. Specifically, the control circuit 160 controls a current value of the charging current in constant-current charging, and at the same time, switches between the charging by the first charging circuit 110 and the charging by the second charging circuit 120 based on the current value. It is assumed that a mode in which charging is performed by the first charging circuit 110 is called a first current mode, and a mode in which charging is performed by the second charging circuit 120 is called a second current mode. The control circuit 160 includes a current controller 162 and a control signal output section 161.

The current controller 162 outputs current setting signal D1IN through D13IN for setting the current value of the charging current IBAT. The current setting signal is a signal consisting of 13 bits, wherein D1IN corresponds to a first bit signal, D2IN corresponds to a second bit signal, . . . , and D13IN corresponds to a 13-th bit signal. D1IN corresponds to the LSB, and D13IN corresponds to the MSB. It should be noted that it is sufficient for the current setting signal to be a signal consisting of n bits. The character n denotes an integer equal to or greater than 3. The current controller 162 sets the current value of the charging current based on, for example, a detection result from a detection circuit not shown for detecting a battery voltage VBAT.

The control signal output section 161 outputs a first enable signal EN1 in the first current mode, a second enable signal EN2 in the second current mode, and the current source control signal D1 through D13 based on the current setting signal D1IN through D13IN. When the first enable signal EN1 is active, the first charging circuit 110 outputs the first charging current ICH1, and when the second enable signal EN2 is active, the second charging circuit 120 outputs the second charging current ICH2. The current source control signal is a signal consisting of 13 bits, wherein D1 corresponds to a first control bit signal, D2 corresponds to a second control bit signal, . . . , and D13 corresponds to a 13-th control bit signal. D1 corresponds to the LSB, and D13 corresponds to the MSB. It should be noted that it is sufficient for the current source control signal to be a signal consisting of n bits.

The current source circuit 140 supplies an output current set by the current source control signal D1 through D13 to the first charging circuit 110 and the second charging circuit 120 based on the reference voltage VREF. When the first enable signal EN1 is active, the current source circuit 140 supplies the first charging circuit 110 with the first current IS1 as the output current. When the second enable signal EN2 is active, the current source circuit 140 supplies the second charging circuit 120 with the second current IS2 as the output current.

A power supply node NIN is supplied with the power supply voltage VIN. The power supply voltage VIN is supplied from, for example, an external power supply of the circuit device 100. Alternatively, the circuit device 100 can include an incoming circuit, a voltage conversion circuit, or the like which is not shown, and is supplied with the power from the external power supply to output the power supply voltage VIN.

In the first current mode, the first charging circuit 110 outputs the first charging current ICH1 to the output node NCSR based on the power supply voltage VIN and the first current IS1. Specifically, the first charging circuit 110 amplifies the first current IS1 with a first gain, and then outputs the current thus amplified as the first charging current ICH1.

In the second current mode, the second charging circuit 120 outputs the second charging current ICH2 to the output node NCSR based on the power supply voltage VIN and the second current IS2. Specifically, the second charging circuit 120 amplifies the second current IS2 with a second gain, and then outputs the current thus amplified as the second charging current ICH2. The current value of the second charging current ICH2 is higher than the current value of the first charging current ICH1.

When the current setting signal D1IN through D13IN for setting the charging current IBAT lower than a threshold value is input, the control signal output section 161 makes the first charging circuit 110 output ICH1=IBAT. When the current setting signal D1IN through D13IN for setting the charging current IBAT no lower than the threshold value is input, the control signal output section 161 makes the second charging circuit 120 output ICH2=IBAT. In other words, defining the threshold value as Ith, ICH1<Ith≤ICH2 is true. It should be noted that the control signal output section 161 may make the first charging circuit 110 output ICH1=IBAT when the current setting signal D1IN through D13IN for setting the charging current IBAT no higher than the threshold value is input, and make the second charging circuit 120 output ICH2=IBAT when the current setting signal D1IN through D13IN for setting the charging current IBAT higher than the threshold value is input.

In the present embodiment, the circuit device 100 includes the current source circuit 140, the first charging circuit 110, the second charging circuit 120, and the control circuit 160. The first charging circuit 110 supplies the charging node NBAT with the first charging current ICH1 which is a constant current as the charging current IBAT based on an output current of the current source circuit 140. The second charging circuit 120 supplies the charging node NBAT with the second charging current ICH2 which is a constant current as the charging current IBAT based on the output current of the current source circuit 140. The second charging current ICH2 is higher than the first charging current ICH1. When it is determined that the current value of the charging current IBAT is the current value in the first current mode, the control circuit 160 performs control in the first current mode of making the first charging circuit 110 supply the charging node NBAT with the first charging current ICH1. When it is determined that the current value of the charging current is the current value in the second current mode higher than the current value in the first current mode, the control circuit 160 performs control in the second current mode of making the second charging circuit 120 supply the charging mode NBAT with the second charging current ICH2.

According to the present embodiment, when it is determined that the current value of the charging current is the current value in the second current mode higher than the current value in the first current mode, switching to the second charging circuit 120 is performed, and there is performed the charging with the second charging current ICH2 higher than the first charging current ICH1. Thus, an increase in charging current is achieved. Further, by switching between the first charging circuit 110 and the second charging circuit 120 in accordance with the current value of the charging current IBAT, it becomes possible to design an optimum constant-current charging circuit in accordance with the current value of the charging current IBAT. Thus, it becomes possible to prevent an increase in circuit scale, a deterioration of the resolution of the charging current, or a deterioration of the power efficiency while realizing the increase in charging current.

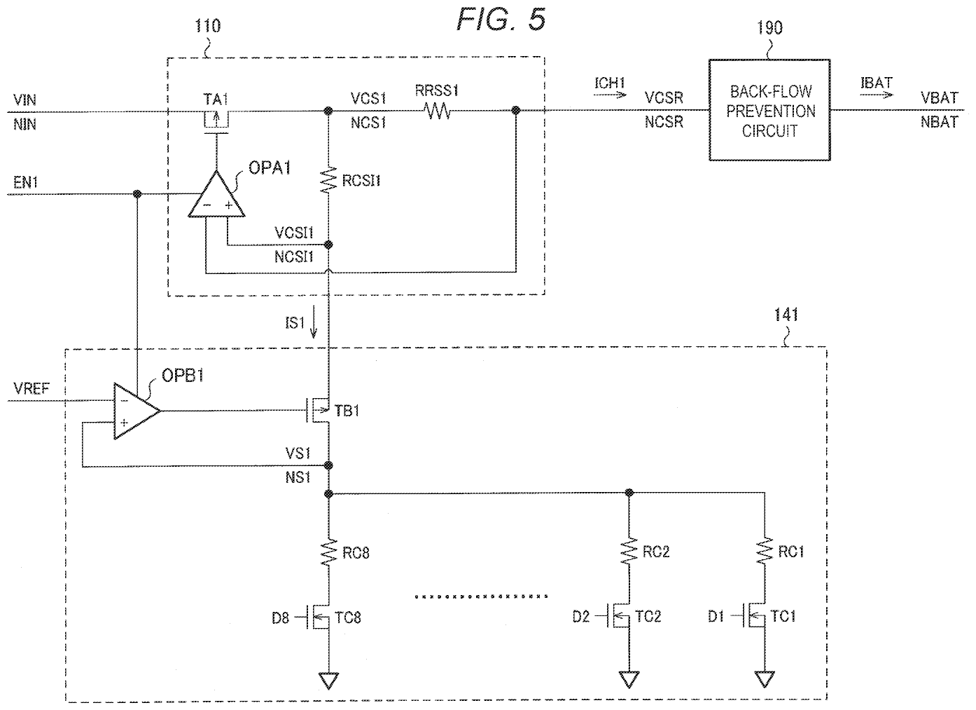

It should be noted that in the example shown in FIG. 3, “when it is determined that the current value of the charging current is the current value in the first current mode” means “when the current setting signal is the signal of setting the charging current lower than the threshold value.” Further, “when it is determined that the current value of the charging current is the current value in the second current mode” means “when the current setting signal is the signal of setting the charging current no lower than the threshold value.” It should be noted that the method of determining the current value of the charging current is not limited to the above. For example, it is possible to arrange that it begins with the first current mode when starting the charging, and dispose a detection circuit for detecting a potential difference of a resistor RRSS1 shown in FIG. 5 described later. It is possible to determine that the current value of the charging current is the current value in the first current mode when the potential difference thus detected is smaller than a predetermined value, and that the current value of the charging current is the current value in the second current mode when the potential difference thus detected is no smaller than the predetermined value.

Further, in the present embodiment, the control circuit 160 determines which one of the control in the first current mode and the control in the second current mode is to be performed based on the current setting signal D1IN through D13IN for setting the current value of the charging current IBAT.

According to the present embodiment, it is possible to determine whether the current value of the charging current is the current value in the first current mode or the current value in the second current mode based on the current setting signal D1IN through D13IN. Since it is possible to determine the current value using a logic circuit, it is possible to determine the current value of the charging current with a simple method.

Further, in the present embodiment, when the current value of the charging current IBAT is set to the current value lower than the threshold value, the control circuit 160 performs the control in the first current mode. When the current value of the charging current IBAT is set to the current value no lower than the threshold value, the control circuit 160 performs the control in the second current mode.

According to the present embodiment, the first charging circuit 110 supplies the first charging current ICH1 when the current value of the charging current IBAT is lower than the threshold value, and the second charging circuit 120 supplies the second charging current ICH2 higher than the first charging current ICH1 when the current value of the charging current IBAT is no lower than the threshold value. As described above, the first charging circuit 110 and the second charging circuit 120 are switched in accordance with the current value of the charging current IBAT. It should be noted that it is possible for the control circuit 160 to perform the control in the first current mode when the current value of the charging current IBAT is set to the current value no higher than the threshold value, and perform the control in the second current mode when the current value of the charging current IBAT is set to the current value higher than the threshold value.

### 2. First Embodiment

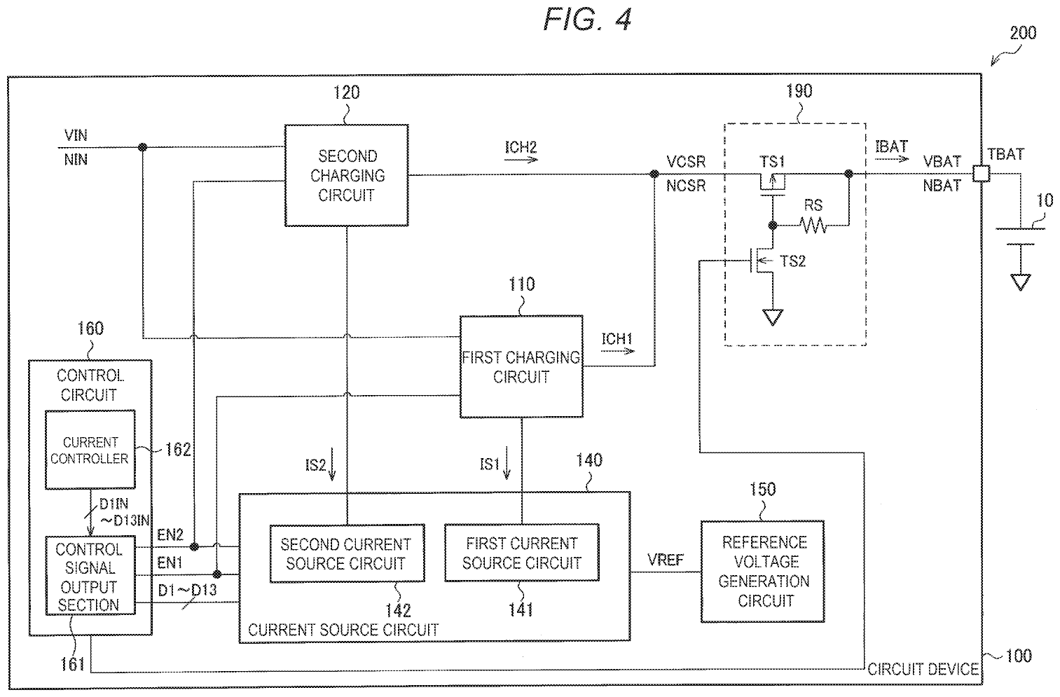

FIG. 4 shows a detailed configuration example of the circuit device 100 according to a first embodiment. In the present configuration example, the current source circuit 140 includes a first current source circuit 141 and a second current source circuit 142. It should be noted that the same constituents as the constituents having already been described are denoted by the same reference numerals, and the description of such constituents will arbitrarily be omitted.

In the first current mode, the first current source circuit 141 generates the first current IS1 having the current value set by the current source control signal D1 through D13, and then supplies the first current IS1 to the first charging circuit 110.

In the second current mode, the second current source circuit 142 generates the second current IS2 having the current value set by the current source control signal D1 through D13, and then supplies the second current IS2 to the second charging circuit 120.

FIG. 5 shows a detailed configuration example of the first charging circuit 110 and the first current source circuit 141. The first charging circuit 110 includes an operational amplifier OPA1, a P-type transistor TA1, a resistor RCSI1, and the resistor RRSS1.

The source of the P-type transistor TA1 is coupled to the power supply node NIN, and the drain thereof is coupled to a node NCS1. The power supply node NIN is supplied with the power supply voltage VIN. One end of the resistor RCSI1 is coupled to the node NCS1, and the other end thereof is coupled to a node NCSI1. One end of the resistor RRSS1 is coupled to the node NCS1, and the other end thereof is coupled to the output node NCSR. A non-inverting input terminal of the operational amplifier OPA1 is coupled to the node NCSI1, an inverting input terminal thereof is coupled to the output node NCSR, and an output node thereof is coupled to the gate of the P-type transistor TA1.

The operational amplifier OPA1 is enabled to operate when the first enable signal EN1 is active. Thus, the first charging current ICH1=(RCSI1/RRSS1)×IS1 is supplied to the output node NCSR, and is supplied to the charging mode NBAT as the charging current IBAT.

The first current source circuit 141 includes an operational amplifier OPB1, a P-type transistor TB1, resistors RC1 through RC8, and N-type transistors TC1 through TC8.

The source of the P-type transistor TB1 is coupled to the node NCSI1, and the drain thereof is coupled to a node NS1. To the inverting input terminal of the operational amplifier OPB1, there is input the reference voltage VREF. A non-inverting input terminal of the operational amplifier OPB1 is coupled to the node NS1, and an output node thereof is coupled to the gate of the P-type transistor TB1. One end of the resistor RC1 is coupled to the node NS1, and the other end thereof is coupled to the drain of the N-type transistor TC1. The source of the N-type transistor TC1 is coupled to the ground node. Similarly, one ends of the resistors RC2 through RC8 are coupled to the node NS1, and the other ends thereof are coupled to the drains of the N-type transistors TC2 through TC8, respectively. The sources of the N-type transistors TC2 through TC8 are coupled to the ground node. To the gate of the N-type transistor TC1, there is input the first control bit signal D1. Similarly, to the gates of the N-type transistors TC2 through TC8, there are input the second through eighth control bit signals D2 through D8, respectively.

The operational amplifier OPB1 is enabled to operate when the first enable signal EN1 is active. Thus, the voltage at the node NS1 becomes VS1=VREF. The resistor RC1 and the N-type transistor TC1 are called a first current source of the first current source circuit 141. When the first control bit signal D1 is 1, the N-type transistor TC1 is in the ON state, and the first current source makes the current of VREF/RC1 flow. Similarly, the resistors RC2 through RC8 and the N-type transistors TC2 through TC8 are called second through eighth current sources of the first current source circuit 141, respectively. When the second through eighth control bit signals D2 through D8 are 1, the N-type transistors TC2 through TC8 are in the ON state, and the second through eighth current sources make the currents of VREF/RC2 through VREF/RC8 flow, respectively. The first current IS1 flowing through the P-type transistor TB1 is a sum of the currents made to flow by the current sources each corresponding to one of the first through eighth control bit signals D1 through D8. It should be noted that the number of the current sources included in the first current source circuit 141 is not limited to 8, and is only required to be m. The reference symbol m denotes an integer no smaller than 2 and no greater than n.

When the first enable signal EN1 is inactive, the operational amplifiers OPA1, OPB1 are disabled to operate. On this occasion, the P-type transistors TA1, TB1 turn OFF, and thus, the first current IS1 and the first charging current ICH1 do not flow.

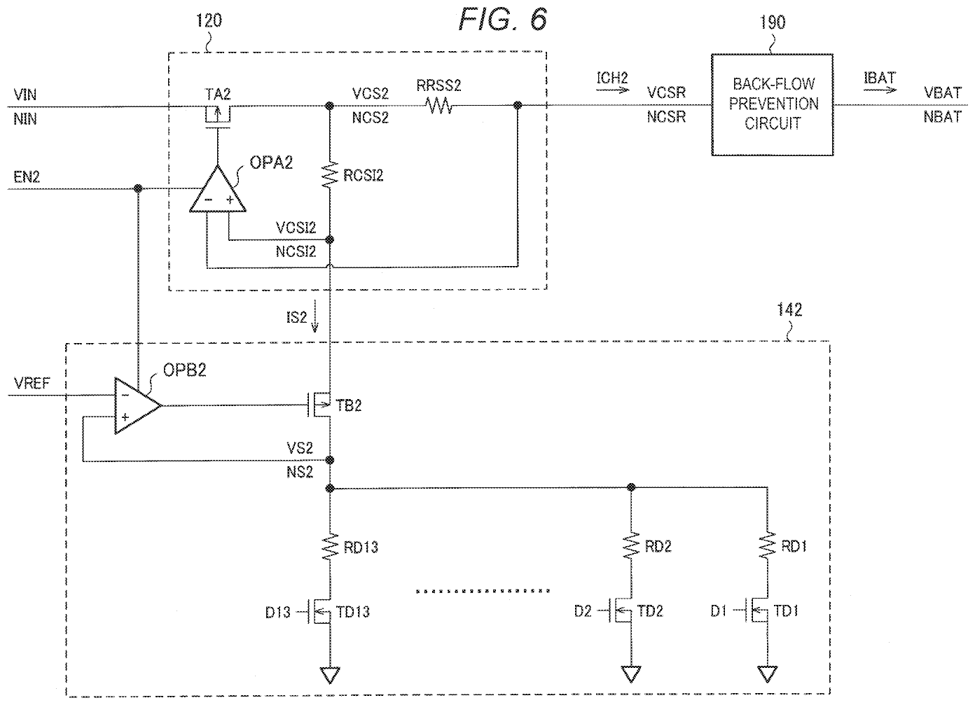

FIG. 6 shows a detailed configuration example of the second charging circuit 120 and the second current source circuit 142. The second charging circuit 120 includes an operational amplifier OPA2, a P-type transistor TA2, a resistor RCSI2, and a resistor RRSS2.

The source of the P-type transistor TA2 is coupled to the power supply node NIN, and the drain thereof is coupled to a node NCS2. One end of the resistor RCSI2 is coupled to the node NCS2, and the other end thereof is coupled to a node NCSI2. One end of the resistor RRSS2 is coupled to the node NCS2, and the other end thereof is coupled to the output node NCSR. A non-inverting input terminal of the operational amplifier OPA2 is coupled to the node NCSI2, an inverting input terminal thereof is coupled to the output node NCSR, and an output node thereof is coupled to the gate of the P-type transistor TA2.

The operational amplifier OPA2 is enabled to operate when the second enable signal EN2 is active. Thus, the second charging current ICH2=(RCSI2/RRSS2)×IS2 is supplied to the output node NCSR, and is supplied to the charging mode NBAT as the charging current IBAT.

The second current source circuit 142 includes an operational amplifier OPB2, a P-type transistor TB2, resistors RD1 through RD13, and N-type transistors TD1 through TD13.

The source of the P-type transistor TB2 is coupled to the node NCSI2, and the drain thereof is coupled to a node NS2. To the inverting input terminal of the operational amplifier OPB2, there is input the reference voltage VREF. A non-inverting input terminal of the operational amplifier OPB2 is coupled to the node NS2, and an output node thereof is coupled to the gate of the P-type transistor TB2. One end of the resistor RD1 is coupled to the node NS2, and the other end thereof is coupled to the drain of the N-type transistor TD1. The source of the N-type transistor TD1 is coupled to the ground node. Similarly, one ends of the resistors RD2 through RD13 are coupled to the node NS2, and the other ends thereof are coupled to the drains of the N-type transistors TD2 through TD13, respectively. The sources of the N-type transistors TD2 through TD13 are coupled to the ground node. To the gate of the N-type transistor TD1, there is input the first control bit signal D1. Similarly, to the gates of the N-type transistors TD2 through TD13, there are input the second through 13-th control bit signals D2 through D13, respectively.

The operational amplifier OPB2 is enabled to operate when the second enable signal EN2 is active. Thus, the voltage at the node NS2 becomes VS2=VREF. The resistor RD1 and the N-type transistor TD1 are called a first current source of the second current source circuit 142. When the first control bit signal D1 is 1, the N-type transistor TD1 is in the ON state, and the first current source makes the current of VREF/RD1 flow. Similarly, the resistors RD2 through RD13 and the N-type transistors TD2 through TD13 are called second through 13-th current sources of the second current source circuit 142, respectively. When the second through 13-th control bit signals D2 through D13 are 1, the N-type transistors TD2 through TD13 are in the ON state, and the second through 13-th current sources make the currents of VREF/RD2 through VREF/RD13 flow, respectively. The second current IS2 flowing through the P-type transistor TB2 is a sum of the currents made to flow by the current sources each corresponding to one of the first through 13-th control bit signals D1 through D13. It should be noted that the number of the current sources included in the second current source circuit 142 is not limited to 13, and is only required to be n.

When the second enable signal EN2 is inactive, the operational amplifiers OPA2, OPB2 are disabled to operate. On this occasion, the P-type transistors TA2, TB2 turn OFF, and thus, the second current IS2 and the second charging current ICH2 do not flow.

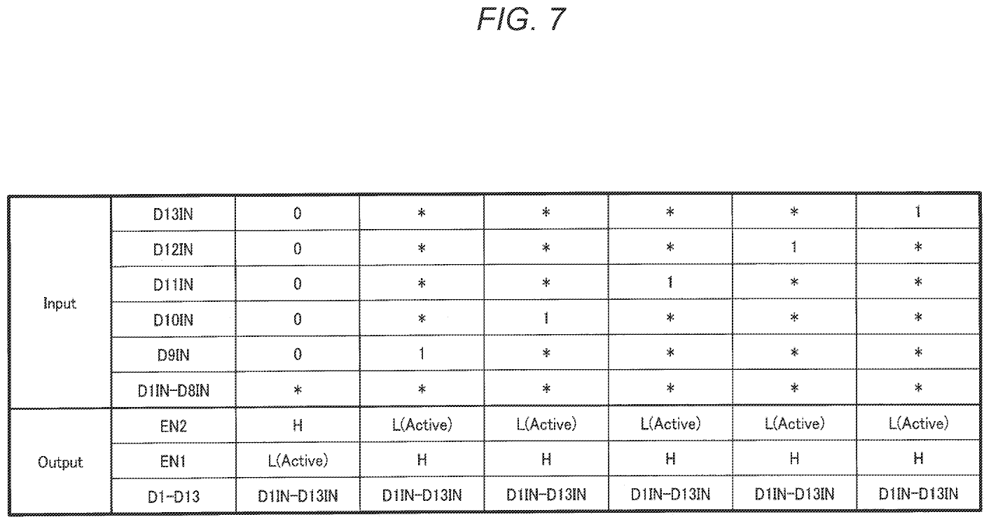

FIG. 7 is an explanatory diagram of an operation of a control signal output section 161 in the first embodiment. The symbol “*” represents don't-care, namely the fact that either of 0 and 1 can be applied.

When all of the ninth through 13-th bit signals D9IN through D13IN of the current setting signal are 0, the control signal output section 161 sets the circuit device 100 in the first current mode, and outputs EN1=L, EN2=H. The character L represents the low level, and the character H represents the high level. Here, it is assumed that the first enable signal EN1 and the second enable signal EN2 are active in the low level. When any one of the ninth through 13-th bit signals D9IN through D13IN is 1, the control signal output section 161 sets the circuit device 100 in the second current mode, and outputs EN1=H, EN2=L. In the first embodiment, the first through 13-th control bit signals of the current source control signal are set as D1=D1IN, D2=D2IN, . . . , and D13=D13IN.

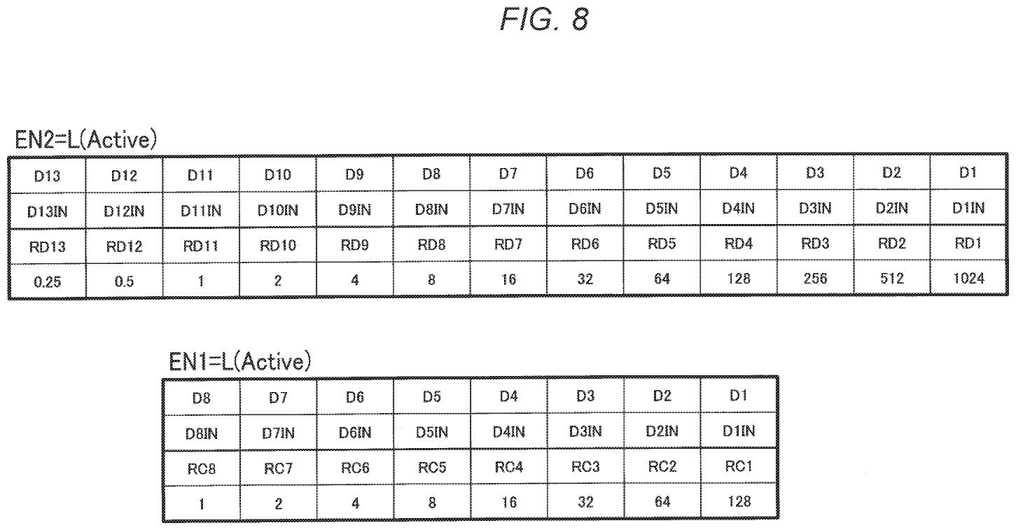

FIG. 8 is a diagram for explaining a resistance ratio and an operation of the current source circuit corresponding to each of the current modes in the first embodiment. As shown in a lower drawing, in the first current source circuit 141 operating in the first current mode, the resistance ratio is RC8:RC7: . . . :RC1=1:2: . . . :128. For example, when the resistor RC8 is formed of one unit resistor, the resistor RC7 is formed of two unit resistors coupled in series to each other. The same applies to the resistors RC6 through RC1. The first current source circuit 141 is controlled by the first through eighth control bit signals D1 through D8 of the current source control signal wherein D1=D1IN, D2=D2IN, . . . , and D8=D8IN are assumed.

As shown in an upper drawing in FIG. 8, in the second current source circuit 142 operating in the second current mode, the resistance ratio is RD13:RD12:RD11:RD10: . . . :RD1=0.25:0.5:1:2: . . . :512:1024. For example, when the resistor RD11 is formed of one unit resistor, the resistor RD10 is formed of two unit resistors coupled in series to each other. The same applies to the resistors RD9 through RD1. Further, the resistor RD12 is formed of two unit resistors coupled in parallel to each other, and the resistor RD13 is formed of four unit resistors coupled in parallel to each other. The second current source circuit 142 is controlled by the first through 13-th control bit signals D1 through D13 of the current source control signal wherein D1=D1IN, D2=D2IN, and D13=D13IN are assumed.

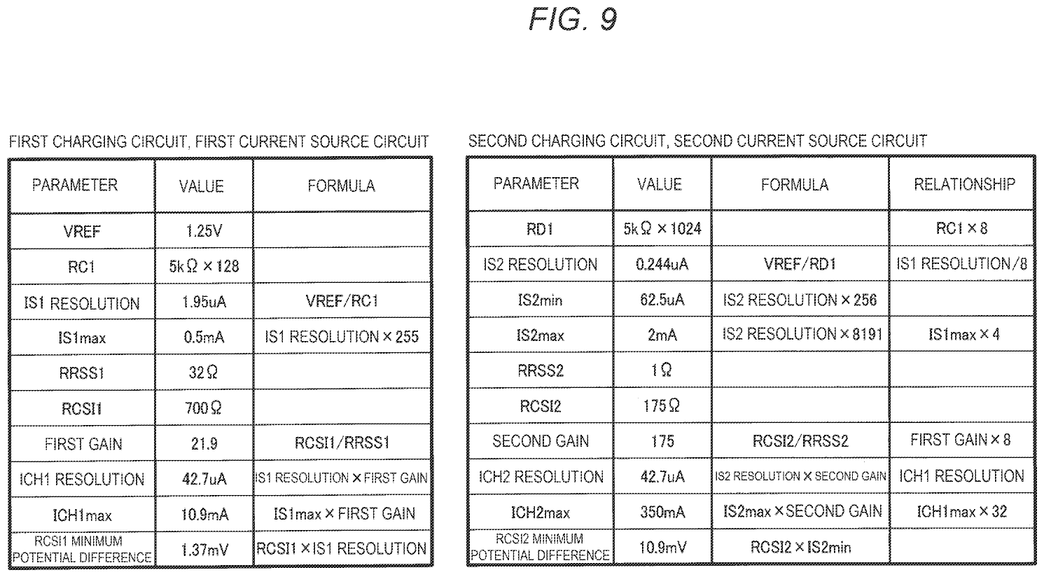

A left drawing in FIG. 9 shows a parameter example of the first charging circuit 110 and the first current source circuit 141, and a right drawing in FIG. 9 shows a parameter example of the second charging circuit 120 and the second current source circuit 142. The right drawing also shows relationships with the parameters in the left drawing. The reference voltage is assumed as VREF=1.25 V. Further, the unit resistor is assumed as 5 kΩ. It should be noted that in the description in FIG. 9 and the following drawings, there are described rounded numerical values as needed.

As shown in the left drawing, RC1=5 kΩ×128 is true, and the resolution of the first current IS1 becomes VREF/RC1=1.95 μA. The maximum value IS1max of the first current is (IS1 resolution)×256=0.5 mA. When RRSS1=32Ω and RCSI1=700Ω are assumed, the first gain is RCSI1/RRSS1=21.9. The resolution of the first charging current ICH1 becomes (IS1 resolution)×(first gain)=42.7 μA, and the maximum value ICH1max of the first charging current becomes IS1max×(first gain)=10.9 mA. A minimum potential difference between both ends of the resistor RCSI1 becomes RCSI1×(IS1 resolution)=1.37 mV.

As shown in the right drawing, RD1=5 kΩ×1024 is true, and the resolution of the second current IS2 becomes VREF/RD1=0.244 μA. When D13=D12= . . . =D10=0, D9=1, and D8=D7= . . . =D1=0 are true, the second current takes a minimum value IS2min=(IS2 resolution)×256=62.5 μA. A maximum value IS2max of the second current is (IS2 resolution)×8191=2 mA. When RRSS2=1Ω and RCSI2=175Ω are assumed, the second gain is RCSI2/RRSS2=175. The resolution of the second charging current ICH2 becomes (IS2 resolution)×(second gain)=42.7 μA, and the maximum value ICH2max of the second charging current becomes IS2max×(second gain)=350 mA. A minimum potential difference between both ends of the resistor RCSI2 becomes RCSI2×IS2min=10.9 mV. It should be noted that the relationships with the parameters in the left drawing are as illustrated.

A minimum value of the second charging current ICH2 is as follows.

$$\begin{matrix}IS 2 min \times ( second gain ) = \{ ( ( IS 1 resolution ) / 8 ) \times 256 \} \times ( ( first gain ) \times 8 ) \\ = ( IS 1 resolution ) \times 256 \times ( first gain ) \\ = IS 1 max + ( IS 1 resolution ) \times ( first gain )\end{matrix}$$

Further, (ICH1 resolution)=(ICH2 resolution) is true. In other words, the charging current IBAT is made linear with respect to the current setting signal D1IN through D13IN. It should be noted that FIG. 9 and the explanation described above are nothing more than an example of the parameters, and the parameters of the first charging circuit 110 and the first current source circuit 141 are not limited to the parameters in FIG. 9 and the explanation described above.

In the present embodiment, since the first charging circuit 110 and the first current source circuit 141 for the low charging current, and the second charging circuit 120 and the second current source circuit 142 for the high charging current are provided, it is possible to appropriately design the parameters of the charging circuits and the current source circuits. Thus, it becomes possible to prevent an increase in circuit scale, a deterioration of the resolution of the charging current, or a deterioration of the power efficiency while realizing the increase in charging current. Specifically, the resistor RD1 in the second current source circuit 142 is constituted by 5 kΩ×1024, and thus, an increase in scale is suppressed compared to the resistor RZ1 in the second example shown in FIG. 2. Further, the RCSI1 minimum potential difference is 1.37 mV, and the RCSI2 minimum potential difference is 10.9 mV. These values are sufficiently larger compared to the RCSI minimum potential difference in the second example shown in FIG. 2. Thus, it is possible to chop the first charging current ICH1 and the second charging current ICH2 with the resolution higher in accuracy. Further, the maximum value of the second current IS2 is suppressed to 2 mA while realizing suppression of the increase in circuit scale, and the increase in resolution of the charging current, and thus the deterioration of the power efficiency is prevented.

In the present embodiment described hereinabove, the first charging circuit 110 is supplied with the first current IS1 as the output current from the current source circuit 140, and amplifies the first current IS1 with the first gain in the first current mode to thereby supply the first charging current ICH1. The second charging circuit 120 is supplied with the second current IS2 as the output current from the current source circuit 140, and amplifies the second current IS2 with the second gain in the second current mode to thereby supply the second charging current ICH2. The second gain is higher than the first gain.

According to the present embodiment, since the second gain in the second current mode is higher than the first gain in the first current mode, it is possible to generate the second charging current higher than the first charging current in the second current mode. Further, as described with reference to FIG. 9, (ICH1 resolution)=(ICH2 resolution) is true, (ICH1 resolution)=(IS1 resolution)×(first gain) is true, and (RCSI1 minimum potential difference)=RCSI1×(IS1 resolution) is true. By the first gain being lower than the second gain, it is possible to make the IS1 resolution high, and therefore, it is possible to make the RCSI1 minimum potential difference large. Thus, it becomes possible to chop the first charging current ICH1 with the accurate resolution. Further, although the IS2 resolution becomes lower than the IS1 resolution, (RCSI2 minimum potential difference)=RCSI2×IS2min is true since the first charging circuit 110 and the second charging circuit 120 are separated from each other. Thus, the resolution of the second charging current ICH2 becomes the same in value as the resolution of the first charging current ICH1, and it becomes possible to chop the second charging current ICH2 with a more accurate resolution similarly to the first charging current ICH1.

Further, in the present embodiment, the current source circuit 140 includes the first current source circuit 141 for supplying the first current IS1 to the first charging circuit 110, and the second current source circuit 142 for supplying the second current IS2 to the second charging circuit 120.

According to the present embodiment, since the first current source circuit 141 for the low charging current and the second current source circuit 142 for the high charging current are provided, it is possible to appropriately design the resistance values of the current sources of each of the current source circuits.

Further, in the present embodiment, the control circuit 160 outputs the first through n-th bit signals D1IN through DnIN of the current setting signal for setting the current value of the charging current IBAT as the first through n-th control bit signals D1 through Dn of the current source control signal for controlling the first current source circuit 141 and the second current source circuit 142. The first current source circuit 141 includes the m current sources for outputting m constant currents having the binary-weighted current values, respectively. The first current source circuit 141 outputs the constant current selected from the m constant currents based on the first through m-th control bit signals D1 through Dm as the first current IS1. The second current source circuit 142 includes the n current sources for outputting n constant currents having the binary-weighted current values, respectively. The second current source circuit outputs the constant current selected from the n constant currents based on the first through n-th control bit signals D1 through Dn as the second current IS2.

According to the present embodiment, in the first current mode, by the current value of the first current IS1 being set by the current setting signal, the current value of the first charging current ICH1 is set. In the second current mode, by the current value of the second current IS2 being set by the current setting signal, the current value of the second charging current ICH2 is set.

It should be noted that in the example shown in FIG. 3 through FIG. 9, n=13 is assumed, and m=8 is assumed. It should be noted that it is sufficient for n to be an integer no smaller than 3, and it is sufficient for m to be an integer no smaller than 2 and no larger than n.

### 3. Second Embodiment

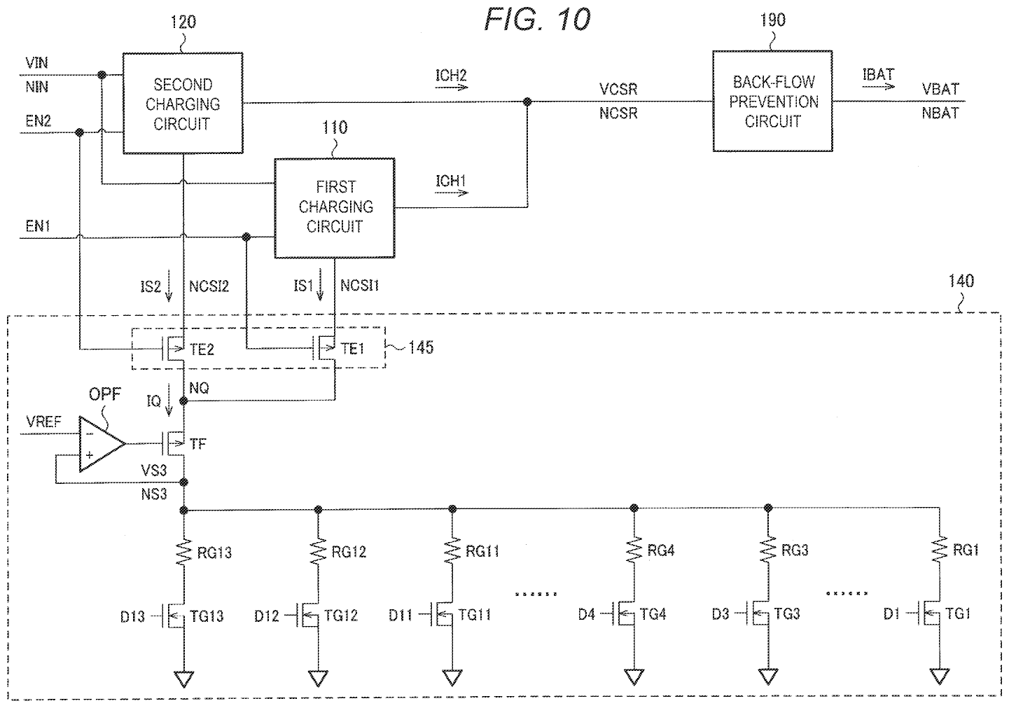

FIG. 10 shows a detailed configuration example of the current source circuit 140 in a second embodiment. In the present configuration example, the current source circuit 140 includes an operational amplifier OPF, a switch circuit 145, a P-type transistor TF, resistors RG1 through RG13, and N-type transistors TG1 through TG13. It should be noted that the detailed configuration example of the first charging circuit 110, the second charging circuit 120, and the back-flow prevention circuit 190 is substantially the same as shown in FIG. 3, FIG. 5, and FIG. 6.

The switch circuit 145 includes P-type transistors TE1, TE2. The source of the P-type transistor TE1 is coupled to the node NCSI1, and the drain thereof is coupled to a node NQ. The source of the P-type transistor TE2 is coupled to the node NCSI2, and the drain thereof is coupled to the node NQ. When the first enable signal EN1 is in the low level, the P-type transistor TE1 is in the ON state, and a current IQ flowing into the P-type transistor TF flows through the node NCSI1 as the first current IS1. When the second enable signal EN2 is in the low level, the P-type transistor TE2 is in the ON state, and the current IQ flowing into the P-type transistor TF flows through the node NCSI2 as the second current IS2.

The source of the P-type transistor TF is coupled to the node NQ, and the drain thereof is coupled to a node NS3. To an inverting input terminal of the operational amplifier OPF, there is input the reference voltage VREF. A non-inverting input terminal of the operational amplifier OPF is coupled to the node NS3, and an output node thereof is coupled to the gate of the P-type transistor TF. One end of the resistor RG1 is coupled to the node NS3, and the other end thereof is coupled to the drain of the N-type transistor TG1. The source of the N-type transistor TG1 is coupled to the ground node. Similarly, one ends of the resistors RG2 through RG13 are coupled to the node NS3, and the other ends thereof are coupled to the drains of the N-type transistors TG2 through TG13, respectively. The sources of the N-type transistors TG2 through TG13 are coupled to the ground node. To the gate of the N-type transistor TG1, there is input the first control bit signal D1. Similarly, to the gates of the N-type transistors TG2 through TG13, there are input the second through 13-th control bit signals D2 through D13, respectively.

The operational amplifier OPF is enabled to operate in either of the first current mode and the second current mode, and the voltage at the node NS3 becomes VS3=VREF. The resistor RG1 and the N-type transistor TG1 are called a first current source of the current source circuit 140. When the first control bit signal D1 is 1, the N-type transistor TG1 is in the ON state, and the first current source makes the current of VREF/RG1 flow. Similarly, the resistors RG2 through RG13 and the N-type transistors TG2 through TG13 are called second through 13-th current sources of the current source circuit 140, respectively. When the second through 13-th control bit signals D2 through D13 are 1, the N-type transistors TG2 through TG13 are in the ON state, and the second through 13-th current sources make the currents of VREF/RG2 through VREF/RG13 flow, respectively. The current IQ flowing through the P-type transistor TF is a sum of the currents made to flow by the current sources each corresponding to one of the first through 13-th control bit signals D1 through D13. It should be noted that the number of the current sources included in the current source circuit 140 is not limited to 13, and is only required to be n.

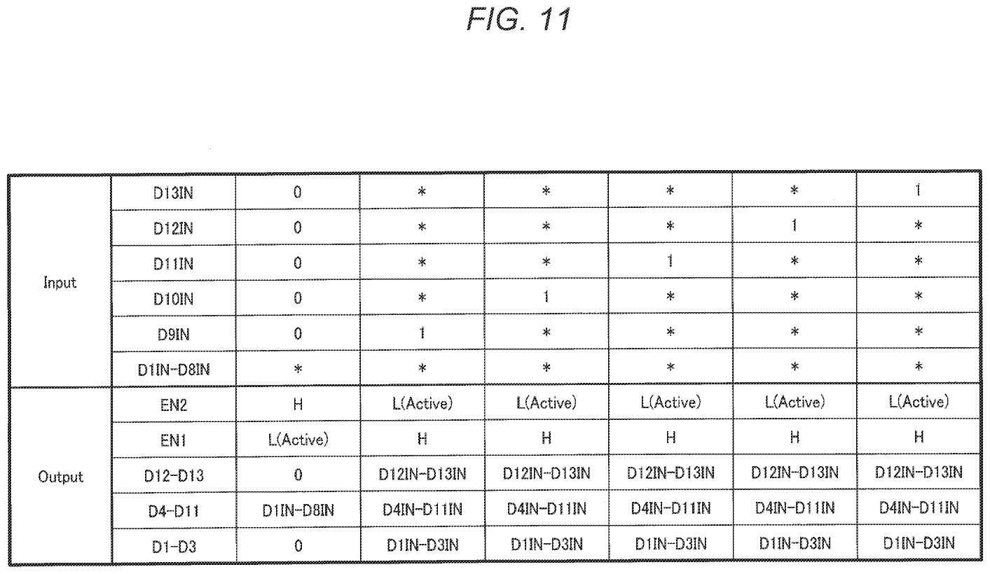

FIG. 11 is an explanatory diagram of an operation of the control signal output section 161 in the second embodiment. The first enable signal EN1 and the second enable signal EN2 are substantially the same as shown in FIG. 7 in the first embodiment.

In the first current mode in which EN1=L is set, the control signal output section 161 outputs the first through eighth bit signals D1IN through D8IN of the current setting signal as the fourth through 11-th control bit signals D4 through D11 of the current source control signal. Specifically, D1=D2=D3=0, D4=D1IN, D5=D2IN, . . . , D11=D8IN, and D12=D13=0 are set.

In the second current mode in which EN2=L is set, the control signal output section 161 outputs the first through 13-th bit signals D1IN through D13IN of the current setting signal as the first through 13-th control bit signals D1 through D13 of the current source control signal. Specifically, D1=D1IN, D2=D2IN, . . . , and D13=D13IN are set.

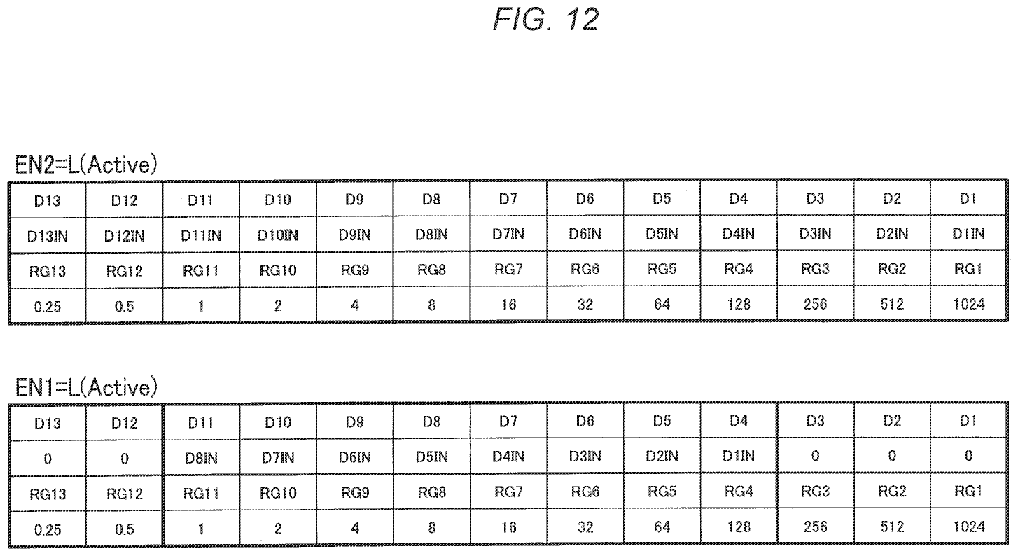

FIG. 12 is a diagram for explaining a resistance ratio and an operation in each of the current modes of the current source circuit in the second embodiment. As shown in an upper drawing and a lower drawing, in the current source circuit 140, the resistance ratio is RG13:RG12:RG11:RG10: . . . :RG1=0.25:0.5:1:2: . . . :1024. For example, when the resistor RG11 is formed of one unit resistor, the resistor RG10 is formed of two unit resistors coupled in series to each other. The same applies to the resistors RG9 through RG1. Further, the resistor RG12 is formed of two unit resistors coupled in parallel to each other, and the resistor RG13 is formed of four unit resistors coupled in parallel to each other.

As shown in the lower drawing, in the first current mode, the current source of the resistor RG4 is controlled by the first bit signal D1IN of the current setting signal, the current source of the resistor RG5 is controlled by the second bit signal D2IN of the current setting signal, . . . , and the current source of the resistor RG11 is controlled by the eighth bit signal D8IN of the current setting signal. The correspondence between the resistance ratio of the resistors and the bits of the current setting signal is made the same as in the lower drawing in FIG. 8. In other words, there is realized current control equivalent to that in the first current source circuit 141 in the first embodiment.

As shown in the upper drawing, in the second current mode, the current source of the resistor RG1 is controlled by the first bit signal D1IN of the current setting signal, the current source of the resistor RG2 is controlled by the second bit signal D2IN of the current setting signal, . . . , and the current source of the resistor RG13 is controlled by the 13-th bit signal D13IN of the current setting signal. The correspondence between the resistance ratio of the resistors and the bits of the current setting signal is made the same as in the upper drawing in FIG. 8. In other words, there is realized current control equivalent to that in the second current source circuit 142 in the first embodiment.

As described hereinabove, the current source circuit 140 in the second embodiment realizes the current control equivalent to those of the first current source circuit 141 and the second current source circuit 142 while commonalizing the first current source circuit 141 and the second current source circuit 142 in the first embodiment. Thus, it is possible to further reduce the circuit scale from that in the first embodiment.

In the present embodiment described hereinabove, the current source circuit 140 includes the switch circuit 145 and the first through n-th current sources. In the first current mode, the switch circuit 145 supplies the current IQ from the first through n-th current sources to the first charging circuit 110 as the first current IS1. In the second current mode, the switch circuit 145 supplies the current IQ from the first through n-th current sources to the second charging circuit 120 as the second current IS2.

According to the present embodiment, it is possible to supply the first current IS1 in the first current mode and the second current IS2 in the second current mode by the first through n-th current sources common to the both modes. Thus, it is possible to further reduce the circuit scale of the current source circuit 140 from that in the first embodiment.

Further, in the present embodiment, in the second current mode, the control circuit 160 outputs the first through n-th bit signals D1IN through DnIN of the current setting signal for setting the current value of the charging current IBAT as the first through n-th control bit signals D1 through Dn of the current source control signal for controlling the current source circuit 140. In the first current mode, the control circuit 160 outputs the first through m-th bit signals D1IN through DmIN as the (i+1)-th through (i+m)-th control bit signals Di+1 through Di+m. The first through n-th current sources output the first through n-th constant currents having the binary-weighted current values. In the second current mode, the switch circuit 145 outputs the constant current selected from the first through n-th constant currents by the first through n-th control bit signals D1 through Dn as the second current IS2. In the first current mode, the switch circuit 145 outputs the constant current selected from the (i+1)-th through (i+m)-th constant currents by the (i+1)-th through (i+m)-th control bit signals Di+1 through Di+m as the first current IS1.

According to the present embodiment, in the second current mode, by the first through n-th constant currents being selected by the first through n-th bit signals D1IN through DnIN of the current setting signal, the current value of the second charging current ICH2 is set. In the first current mode, by the (i+1)-th through (i+m)-th constant currents being selected by the first through m-th bit signals D1IN through DmIN, the current value of the first charging current ICH1 is set. Thus, it is possible to supply the first current IS1 in the first current mode and the second current IS2 in the second current mode by the first through n-th current sources common to the both modes.

It should be noted that in the example shown in FIG. 10 through FIG. 12, n=13 is assumed, m=8 is assumed, and i=3 is assumed. It should be noted that it is sufficient for n to be an integer no smaller than 3, it is sufficient for m to be an integer no smaller than 2 and no larger than n, and it is sufficient for i to be an integer which fulfills that i+1 is no smaller than 1, and i+m is no larger than n.

### 4. Outline

The circuit device according to the present embodiment described hereinabove includes the current source circuit, the first charging circuit, the second charging circuit, and the control circuit. The first charging circuit supplies a charging node with a first charging current which is a constant current as a charging current based on an output current of the current source circuit. The second charging circuit supplies the charging node with a second charging current which is a constant current and is higher than the first charging current as the charging current based on the output current of the current source circuit. When a current value of the charging current is determined as a current value in a first current mode, the control circuit performs control in the first current mode of making the first charging circuit supply the charging node with the first charging current. When the current value of the charging current is determined as a current value in a second current mode higher than the current value in the first current mode, the control circuit performs control in the second current mode of making the second charging circuit supply the charging node with the second charging current.

According to the present embodiment, when it is determined that the current value of the charging current is the current value in the second current mode higher than the current value in the first current mode, switching to the second charging circuit is performed, and there is performed the charging with the second charging current higher than the first charging current. Thus, an increase in charging current is achieved. Further, by switching between the first charging circuit and the second charging circuit in accordance with the current value of the charging current, it becomes possible to design an optimum constant-current charging circuit in accordance with the current value of the charging current. Thus, it becomes possible to prevent an increase in circuit scale, a deterioration of the resolution of the charging current, or a deterioration of the power efficiency while realizing the increase in charging current.

Further, in the present embodiment, the control circuit may determine which one of the control in the first current mode and the control in the second current mode is to be performed based on a current setting signal configured to set the current value of the charging current.

According to the present embodiment, it is possible to determine whether the current value of the charging current is the current value in the first current mode or the current value in the second current mode based on the current setting signal. Since it is possible to determine the current value using a logic circuit, it is possible to determine the current value of the charging current with a simple method.

Further, in the present embodiment, when the current value of the charging current is set to a current value lower than a threshold value, the control circuit may perform the control in the first current mode. When the current value of the charging current is set to a current value no lower than the threshold value, the control circuit may perform the control in the second current mode.

According to the present embodiment, the first charging circuit supplies the first charging current when the current value of the charging current is lower than the threshold value, and the second charging circuit supplies the second charging current higher than the first charging current when the current value of the charging current is no lower than the threshold value. As described above, the first charging circuit and the second charging circuit are switched in accordance with the current value of the charging current.

Further, in the present embodiment, the first charging circuit may be supplied with a first current as the output current from the current source circuit, and may amplify the first current with a first gain in the first current mode to thereby supply the first charging current. The second charging circuit may be supplied with a second current as the output current from the current source circuit, and may amplify the second current with a second gain higher than the first gain in the second current mode to thereby supply the second charging current.

According to the present embodiment, since the second gain in the second current mode is higher than the first gain in the first current mode, it is possible to generate the second charging current higher than the first charging current in the second current mode. Further, since the first gain is lower than the second gain, it is possible to increase the resolution of the first current. Thus, it becomes possible to chop the first charging current with the accurate resolution. Further, although the resolution of the second current becomes lower than the resolution of the first current, by separating the first charging circuit and the second charging circuit from each other, it becomes possible to chop the second charging current with the accurate resolution.

Further, in the present embodiment, the current source circuit may include a first current source circuit configured to supply the first current to the first charging circuit, and a second current source circuit configured to supply the second current to the second charging circuit.

According to the present embodiment, since the first current source circuit for the low charging current and the second current source circuit for the high charging current are provided, it is possible to appropriately design the resistance values of the current sources of each of the current source circuits.

Further, in the present embodiment, the control circuit may output the first through n-th bit signals of the current setting signal for setting the current value of the charging current as the first through n-th control bit signals of the current source control signal for controlling the first current source circuit and the second current source circuit. The first current source circuit may include m current sources configured to output m constant currents having binary-weighted current values. The first current source circuit may output the constant current selected from the m constant currents based on the first through m-th control bit signals out of the first through n-th control bit signals as the first current. The second current source circuit may include n current sources configured to output n constant currents having binary-weighted current values. The second current source circuit may output the constant current selected from the n constant currents based on the first through n-th control bit signals as the second current.

According to the present embodiment, in the first current mode, by the current value of the first current being set by the current setting signal, the current value of the first charging current is set. In the second current mode, by the current value of the second current being set by the current setting signal, the current value of the second charging current is set.

Further, in the present embodiment, the current source circuit may include the first through n-th current sources and a switch circuit. The switch circuit may supply the first charging circuit with a current from the first through n-th current sources as the first current in the first current mode, and may supply the second charging circuit with a current from the first through n-th current sources as the second current in the second current mode.

According to the present embodiment, it is possible to supply the first current in the first current mode and the second current in the second current mode by the first through n-th current sources common to the both modes. Thus, it is possible to further reduce the circuit scale of the current source circuit from that in the first embodiment.

Further, in the present embodiment, the control circuit may output the first through n-th bit signals of the current setting signal for setting the current value of the charging current as the first through n-th control bit signals of the current source control signal for controlling the current source circuit in the second current mode. The control circuit may output the first through m-th bit signals out of the first through n-th bit signals as the (i+1)-th through (i+m)-th control bit signals out of the first through the n-th control bit signals in the first current mode. The first through n-th current sources may output the first through n-th constant currents having the binary-weighted current values. In the second current mode, the switch circuit may output the constant current selected from the first through n-th constant currents by the first through n-th control bit signals as the second current. In the first current mode, the switch circuit may output the constant current selected from the (i+1)-th through (i+m)-th constant currents out of the first through n-th constant currents by the (i+1)-th through (i+m)-th control bit signals as the first current.

According to the present embodiment, in the second current mode, by the first through n-th constant currents being selected by the first through n-th bit signals of the current setting signal, the current value of the second charging current is set. In the first current mode, by the (i+1)-th through (i+m)-th constant currents being selected by the first through m-th bit signals, the current value of the first charging current is set. Thus, it is possible to supply the first current in the first current mode and the second current in the second current mode by the first through n-th current sources common to the both modes.

Further, an electronic apparatus according to the present embodiment includes any one of the circuit devices described above and a battery to be coupled to the charging node.

It should be noted that although the present embodiments are hereinabove described in detail, it should easily be understood by those skilled in the art that it is possible to make a variety of modifications not substantially departing from the novel matters and the advantages of the present disclosure. Therefore, all of such modified examples should be included in the scope of the present disclosure. For example, a term described at least once with a different term having a broader sense or the same meaning in the specification or the accompanying drawings can be replaced with the different term in any part of the specification or the accompanying drawings. Further, all of the combinations of the present embodiments and the modified examples are also included in the scope of the present disclosure. Further, the configurations and the operations of the circuit device, the battery, and the electronic apparatus are not limited to those described in the present embodiments, but can be implemented with a variety of modifications.

What is claimed is:

1. A circuit device comprising:
a current source circuit;
a first charging circuit configured to supply a charging node with a first charging current which is a constant current as a charging current based on an output current of the current source circuit;
a second charging circuit configured to supply the charging node with a second charging current which is a constant current and is higher than the first charging current as the charging current based on the output current of the current source circuit; and
a control circuit, wherein
the control circuit performs
control in a first current mode of making the first charging circuit supply the charging node with the first charging current when a current value of the charging current is determined as a current value in the first current mode, and
control in a second current mode of making the second charging circuit supply the charging node with the second charging current when the current value of the charging current is determined as a current value in the second current mode higher than the current value in the first current mode.

2. The circuit device according to claim 1, wherein
the control circuit determines which one of the control in the first current mode and the control in the second current mode is to be performed based on a current setting signal configured to set the current value of the charging current.

3. The circuit device according to claim 1, wherein
the control circuit performs
the control in the first current mode when the current value of the charging current is set to a current value lower than a threshold value, and
the control in the second current mode when the current value of the charging current is set to a current value no lower than the threshold value.

4. The circuit device according to claim 1, wherein
the first charging circuit is supplied with a first current as the output current from the current source circuit, and amplifies the first current with a first gain in the first current mode to thereby supply the first charging current, and
the second charging circuit is supplied with a second current as the output current from the current source circuit, and amplifies the second current with a second gain higher than the first gain in the second current mode to thereby supply the second charging current.

5. The circuit device according to claim 4, wherein
the current source circuit includes
a first current source circuit configured to supply the first current to the first charging circuit, and
a second current source circuit configured to supply the second current to the second charging circuit.

6. The circuit device according to claim 5, wherein
the control circuit outputs first through n-th bit signals (n is an integer no smaller than 3) of a current setting signal configured to set the current value of the charging current as first through n-th control bit signals of a current source control signal configured to control the first current source circuit and the second current source circuit,
the first current source circuit includes m current sources (m is an integer no smaller than 2 and no larger than n) configured to output m constant currents having binary-weighted current values, and outputs the constant current selected from the m constant currents based on the first through m-th control bit signals out of the first through n-th control bit signals as the first current, and
the second current source circuit includes n current sources configured to output n constant currents having binary-weighted current values, and outputs the constant current selected from the n constant currents based on the first through n-th control bit signals as the second current.

7. The circuit device according to claim 4, wherein
the current source circuit includes
first through n-th current sources, and
a switch circuit configured to supply the first charging circuit with a current from the first through n-th current sources as the first current in the first current mode, and supply the second charging circuit with a current from the first through n-th current sources as the second current in the second current mode.

8. The circuit device according to claim 7, wherein
the control circuit outputs
first through n-th bit signals (n is an integer no smaller than 3) of a current setting signal configured to set the current value of the charging current as first through n-th control bit signals of a current source control signal configured to control the current source circuit in the second current mode, and
first through m-th bit signals (m is an integer no smaller than 2 and no larger than n) out of the first through n-th bit signals as (i+1)-th through (i+m)-th control bit signals (i is an integer which fulfills that i+1 is no smaller than 1 and i+m is no larger than n) out of the first through n-th control bit signals in the first current mode,
the first through n-th current sources output first through n-th constant currents having binary-weighted current values, and
the switch circuit outputs
the constant current selected from the first through n-th constant currents by the first through n-th control bit signals as the second current in the second current mode, and
the constant current selected from (i+1)-th through (i+m)-th constant currents out of the first through n-th constant currents by the (i+1)-th through (i+m)-th control bit signals as the first current in the first current mode.

9. An electronic apparatus comprising:
the circuit device according to claim 1; and
a battery to be coupled to the charging node.
